(19) United States
(12) Patent Application Publication
(10) Pub. No.: US 2004/0236765 A1
(43) Pub. Date: Nov. 25, 2004

(54) Inquiry processing apparatus

(76) Inventors: Hirotaka Matsumura, Kyoto-shi (JP); Yuichi Inagaki, Hirakata-shi (JP); Keiko Ichimura, Toyonaka-shi (JP)

Correspondence Address: SNELL & WILMER LLP, Suite 1200, 1920 Main Street, Irvine, CA, 92614, US

(21) Appl. No.: 10/797,323

(22) Filed: Mar. 9, 2004

(30) Foreign Application Priority Data
Mar. 10, 2003 (JP) 2003-064046

(51) Int. Cl. G06F 17/00

(52) U.S. Cl. 707/100

(57) ABSTRACT

A server 20 includes: a history database 25 for storing a provision history of product pages having been provided to a user terminal; an inquiry receiving unit 26 for receiving an inquiry from the user terminal; a history judging unit 27 for judging with reference to the history database 25 whether a predetermined product page has been provided to the user terminal; and an inquiry providing unit 29 for providing the inquiry and the judgment to a responder terminal. Being provided with the inquiry along with the judgment, a responder can make an appropriate response to the inquiry without going through unnecessary troubles.

### BACKGROUND OF THE INVENTION

(1) Field of the Invention

The present invention relates to technology for providing, to a responder for an inquiry made by a user having viewed web pages that together constitute an electronic catalog, the inquiry along with additional information.

(2) Description of the Related Art

Recently, electronic catalogs are becoming increasingly common. Electronic catalogs are made up of a series of web pages containing various kinds of information about commercial products. Users browse the web pages to acquire information about the products.

Some of electronic catalogs contain inquiry pages for receiving inquiries from users. The inquiry pages are linked to from product pages that contain information about the products.

Generally, each inquiry page has an entry field for entering an inquiry and also has a submit button. A user inputs an inquiry into the entry field and clicks the submit button. With this operation, the inquiry is transmitted to a person in charge of responding to the inquiry (hereinafter, responder). The responder responds to the inquiry by e-mail (see, for example, JP 2002-7887-A).

However, inquiries from users may not contain sufficient information, so that it is difficult for the responder to assume how much knowledge the users have on the products. In such a case, the responder is forced to make a response in generalities that may be common to all users, or to request the users for more specific information. The former response may not be right to the users' points, and the latter inevitably requires the responder to go through extra troubles of making another response at a later time.

### SUMMARY OF THE INVENTION

In view of the above problems, an object of the present invention is to provide an inquiry processing apparatus helping a responder to make an appropriate response without going through unnecessary troubles.

According to one aspect of the present invention, an inquiry processing apparatus is for providing web pages to a browser terminal via a network. The web pages include an inquiry page for entering an inquiry and content pages other than the inquiry page. The inquiry processing apparatus comprises: a recording unit operable to record therein a history of the provision of content pages to the browser terminal; a receiving unit operable to receive an inquiry entered into the inquiry page via the browser terminal; a judging unit operable to judge, when the inquiry is received, whether a predetermined content page has been provided to the browser terminal, based on the history; and a providing unit operable to provide the received inquiry and a result of the judgment to a responder for responding to the inquiry.

With the structure stated above, the inquiry processing apparatus provides the responder with the received inquiry along with the judgment result as to whether the predetermined content page has been provided to the browser terminal. Being provided with the judgment result, the responder can recognize whether a user of the browser terminal has viewed the predetermined content page. That is to say, the responder can make a response to the inquiry with the judgment taken into account.

For example, the web pages together constitute an electronic catalog, and product pages are organized in a hierarchical structure according to how detailed the product information contained in each product page is. Here, the predetermined page is a product page containing information at the most detailed level. In this example, the responder is informed of an inquiry along with whether the user who made the inquiry has viewed the product page containing information at the most detailed level. Generally speaking, users with good knowledge on the products are likely to be the ones who have viewed product pages containing detailed information. Hence, the responder can make an assumption as to how much knowledge that particular user has on the products. This helps the responder to make a suitable response without going through unnecessary troubles.

Here, the inquiry processing apparatus may further comprise a checking unit operable to check, each time a content page is provided to the browser terminal, whether the content page is the predetermined content page. The recording unit records a result of the checking as the history.

With the structure stated above, the inquiry processing apparatus stores the checking results only, so that the memory of the apparatus is effectively used.

According to another aspect of the present invention, an inquiry processing method is for use by an electronic catalog presenting apparatus that provides web pages to a browser terminal via a network. The web pages include an inquiry page for entering an inquiry and content pages other than the inquiry page. The inquiry processing method comprises: a recording step of recording therein a history of the provision of content pages to the browser terminal; a receiving step of receiving an inquiry entered into the inquiry page via the browser terminal; a judging step of judging, when the inquiry is received, whether a predetermined content page has been provided to the browser terminal, based on the history; and a providing step of providing the received inquiry and a result of the judgment to a responder for responding to the inquiry.

With the structure stated above, the inquiry processing method achieves the same effect as the inquiry processing apparatus stated above.

According to yet another aspect of the present invention, an inquiry processing program is for use by a computer that provides web pages to a browser terminal via a network. The web pages include an inquiry page for entering an inquiry and content pages other than the inquiry page. The inquiry processing program comprises: a recording step of recording therein a history of the provision of content pages to the browser terminal; a receiving step of receiving an inquiry entered into the inquiry page via the browser terminal; a judging step of judging, when the inquiry is received, whether a predetermined content page has been provided to the browser terminal, based on the history; and a providing step of providing the received inquiry and a result of the judgment to a responder for responding to the inquiry.

With the program stated above, a computer runs to achieve the same effect as the inquiry processing apparatus stated above.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 is a diagram showing the structures of a user terminal, a server, and a responder terminal;

FIG. 2 is a chart showing operations of the user terminal, the server, and the responder terminal;

FIG. 3 is a diagram showing a hierarchical structure of an electronic catalog;

FIGS. 4 are views showing the contents of a history database;

FIG. 5 shows an example of a screen display on the responder terminal displaying an inquiry;

FIG. 6 is a diagram showing the structures of the user terminal, a server, and the responder terminal;

FIG. 7 is a view showing an example of an HTML file;

FIGS. 8 are views showing the contents of a history database;

FIGS. 9 are views showing a category database, a series database, and a product-code database;

FIG. 10 shows an example of a screen display on the responder terminal displaying an inquiry; and

FIGS. 11 are views showing display examples of inquiry pages.

### DESCRIPTION OF THE PREFERRED EMBODIMENT

Hereinafter, description is given in detail to preferred embodiments of the present invention with reference to the accompanying drawings.

### EMBODIMENT 1

<Overview>

An embodiment 1 relates to a system composed of a user terminal for browsing an electronic catalog, a server for providing the electronic catalog, and a responder terminal used by a responder in change of responding to user inquiries. The electronic catalog is made up of a plurality of product pages and one inquiry page. The product pages are classified into one of the following hierarchical levels according to how detailed the product information contained in the respective pages is: a main-category level, a sub-category level, a series level, and a product-code level. The inquiry page is provided with an entry field for entering an inquiry.

The server of the embodiment 1 receives an inquiry from the user terminal, and stores the inquiry into an inquiry database along with the judgment as to whether the user has viewed any product page at the product-code level. The inquiry and the judgment are provided to the responder terminal.

Generally speaking, users who are well-informed of the products are likely to be the ones who have viewed one or more product pages of the product-code level. Thus, the judgment on the user's browsing history allows the responder to assume how much knowledge the user has on the products. This helps the responder to make an appropriate response to the inquiry without going through unnecessary troubles.

<Structure>

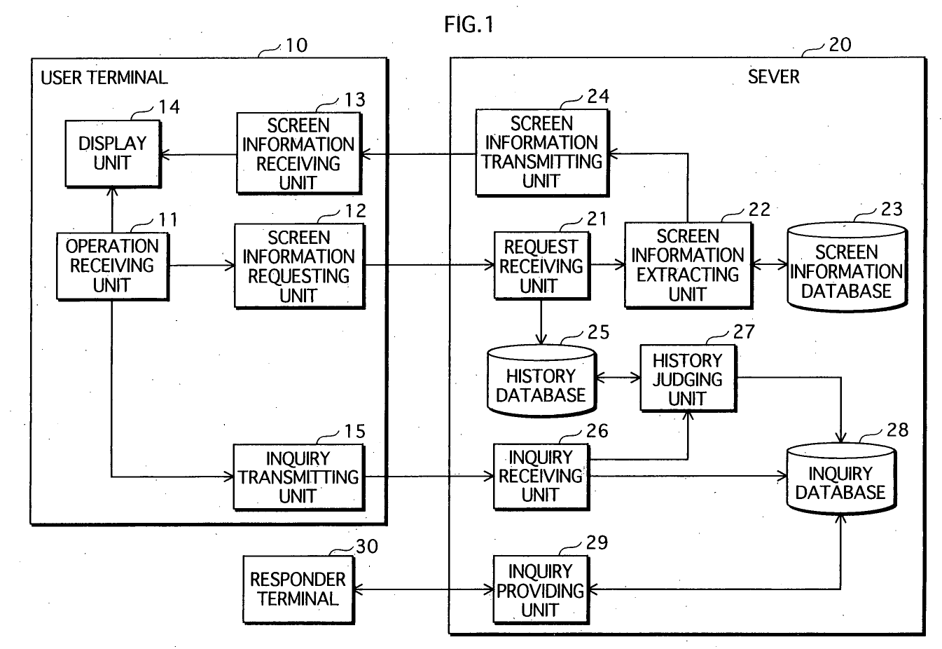

FIG. 1 is a diagram showing the structures of the user terminal, the server, and the responder terminal.

The user terminal 10 is a computer for presenting product pages and an inquiry page of an electronic catalog to the user. The user terminal includes an operation receiving unit 11, a screen information requesting unit 12, a screen information receiving unit 13, a display unit 14, and an inquiry transmitting unit 15.

The server 20 is a web server for providing the electronic catalog, and includes a request receiving unit 21, a screen information extracting unit 22, a screen information database 23, a screen information transmitting unit 24, a history database 25, an inquiry receiving unit 26, a history judging unit 27, an inquiry database 28, and an inquiry providing unit 29.

Specifically speaking, the server 20 is a computer system that is composed mainly of a CPU, ROM, RAM, and hard disk unit. The CPU executes a computer program stored in the ROM or RAM, thereby performing various functions, such as providing electronic catalog.

The responder terminal 30 is a computer for presenting user inquiries to the responder.

Referring back to the user terminal 10, the operation receiving unit 11 receives user operations. The user operations include a click on a link button displayed on a product page, and entering an inquiry to an entry field. At a click on a link button of a product page or a submit button of an inquiry page, information corresponding to the user operation made is passed to the screen information requesting unit 12.

In response, the screen information requesting unit 12 transmits to the server 20 the URL (Uniform Resource Locator) of a requested linked page.

The request receiving unit 21 receives the URL of the linked page, and outputs the received URL to the screen information extracting unit 22 as well as to the history database 25.

With reference to the received URL, the screen information extracting unit 22 extracts from the screen information database 23 an HTML (HyperText Markup Language) file that represents the linked page. The extracted HTML file is then passed to the screen information transmitting unit 24.

The screen information database 23 stores HTML files each representing a different page of the electronic catalog.

The screen information transmitting unit 24 transmits to the screen information receiving unit 13 the HTML file representing the requested liked page.

The history database 25 stores the URL passed from the request receiving unit 21 separately for each user ID. With this arrangement, browsing histories of product pages viewed by users are accumulated on a user-by-user basis.

The screen information receiving unit 13 receives the HTML file that represents the linked page from the screen information transmitting unit 24, and passes the HTML file to the display unit 14.

The display unit 14 interprets the received HTML file with a browser, to display a corresponding page.

The above components are the ones necessary for the user terminal to display a product page that is linked to from a previously displayed page.

Note that a link from a product page is not only to another product page. Each product page contains a link button to jump to the inquiry page at a click on the link button by a user. The inquiry page includes an entry field for making an inquiry and also includes a submit button. An inquiry is received by the operation receiving unit 11 and then passed to the inquiry transmitting unit 15.

The inquiry transmitting unit 15 transmits the inquiry to the inquiry receiving unit 26.

The inquiry receiving unit 26 receives the inquiry, notifies the history judging unit 27 of the reception of the inquiry, and inputs the inquiry to the inquiry database 28.

On receiving the notification from the inquiry receiving unit 26, the history judging unit 27 judges with reference to the history database 25 whether the user has viewed any product page classified as the product-code level. Note that the product-code level is the lowest level in the hierarchal structure of the electronic catalog, and thus pages at this level contain the most detailed product information.

The history judging unit 27 inputs the judgment to the inquiry database 28.

The inquiry database 28 stores the inquiry received from the inquiry receiving unit 26 in association with the judgment received from the history judging unit 27.

The inquiry providing unit 29 provides inquiries stored in the inquiry database 28 to the responder terminal 30 together with the respective judgments. The inquiries stored may be provided to the responder terminal 30 in form of a webpage in response to an access from the responder terminal 30. Alternatively, the inquiries may be provided to the responder terminal 30 by way of e-mail.

Described above are the components necessary for providing user inquiries to the responder.

With the above structure, the server 20 provides an inquiry to the responder along with a judgment as to whether the user who made the inquiry has viewed any product page at the product-code level.

<Operations>

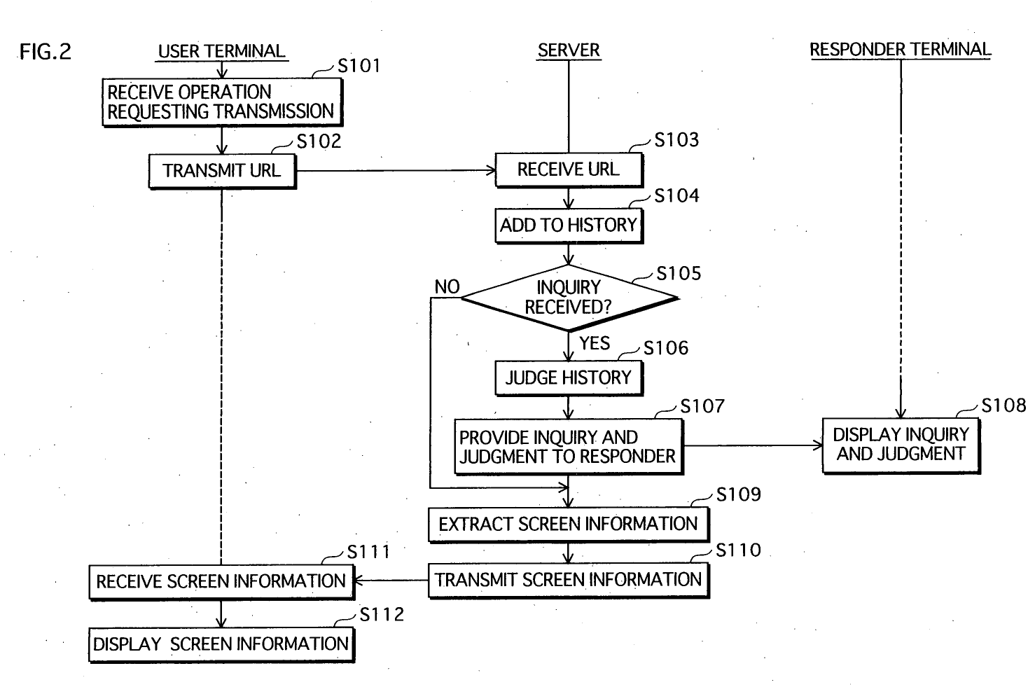

FIG. 2 is a chart showing operations of the user terminal, the server, and the responder terminal.

The user terminal receives a user operation (step S101). The user operation made herein is a click on a link button displayed on a product page or a submit button displayed on the inquiry page.

In response, the user terminal transmits to the server the URL of a linked page (step S102). In the case where the user operation made in the step S101 is a click on the submit button, the URL is transmitted with an inquiry appended thereto.

The server receives the URL (step S103), and stores the URL to the history database as a browsing history of the user (step S104).

The server judges whether the URL is appended with an inquiry (step S105).

When an inquiry is appended (step S105: YES), the server judges with reference to the history database whether the user has viewed any product page at the product-code level (step S106). On the other hand, when no inquiry is appended (step S105: NO), the processing moves onto a step S109.

The server provides the resulting judgment and the inquiry to the responder terminal (step S107).

The responder terminal presents the judgment and the inquiry to the responder (step S108).

The server extracts an HTML file corresponding to the URL from the screen information database (step S109).

The server transmits the extracted HTML file to the user terminal (step S110).

The user terminal receives the HTML file (step S111), and displays a page represented by the HTML file using the browser (step S112).

Hereinafter, description is given to a specific example to which the server descried above is applied.

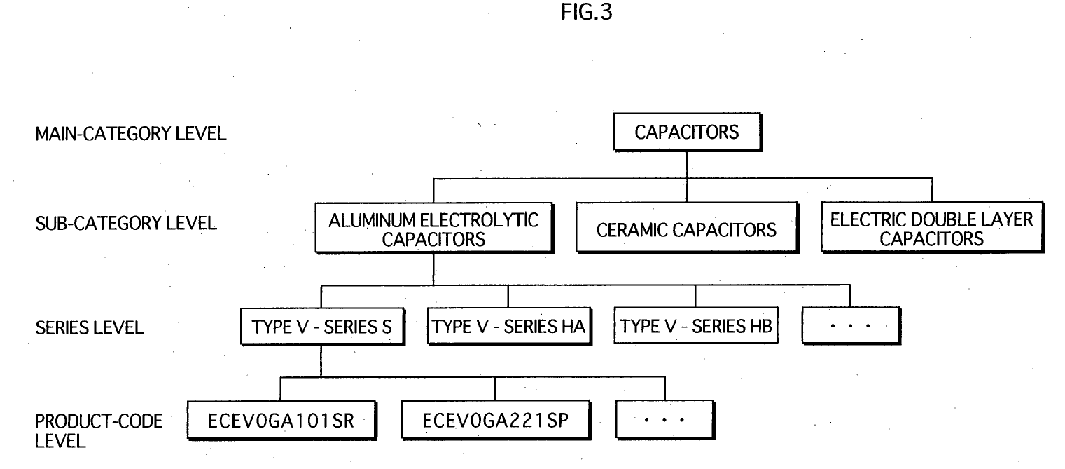

FIG. 3 is a diagram showing a hierarchical structure of an electronic catalog.

The example shown in FIG. 3 is an electronic catalog prepared by a business entity that manufactures and sells electronic components. The electronic catalog contains a plurality of product pages each of which is classified into one of the following four hieratical levels, according to how detailed product information contained in the page is: a main-category level, a sub-category level, a series level, and a product-code level. The product pages contain more and more detailed product information as their levels are closer to the product-code level, which is the lowest level. Further, each product page has a different URL, and a link is made using the URL.

Suppose, for example, a user clicks a link button to a product page of Type V-Series S while viewing a product page of aluminum electrolytic capacitors on the user terminal. In response to the click, the user terminal transmits the URL of a Type V-Series S page to the server. On receiving the URL, the server extracts an HTML file corresponding to the URL from the screen information database and transmits the HTML file back to the user terminal. In addition, the server stores the received URL of the Type V-Series S page in association with a user ID.

Each product page also includes an inquiry button linked to an inquiry page. At a click of the inquiry button, the inquiry page is called onto the user terminal. The user can then enter an inquiry into an entry field of the inquiry page and transmit the inquiry page.

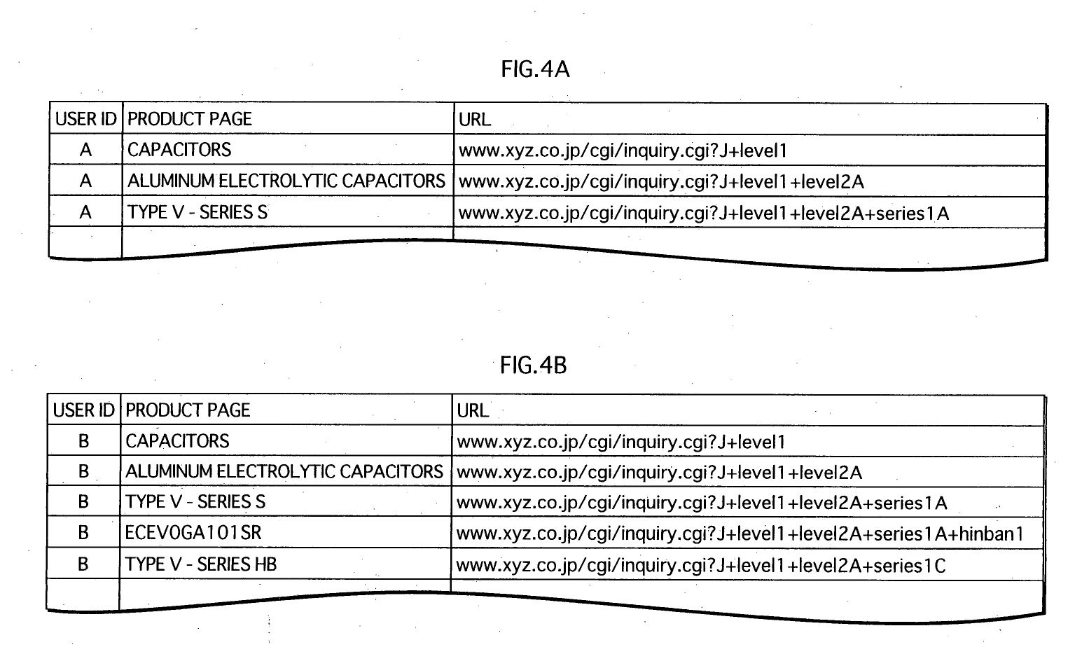

FIGS. 4 are views showing the contents of the history database.

The history database stores, on a user-by-user basis, browsing histories of product pages requested by the respective users.

FIG. 4A is a browsing history of User A.

According to the figure, User A has viewed the product pages of “Capacitors”, “Aluminum Electrolytic Capacitors”, and “Type V-Series S”.

FIG. 4B is a browsing history of User B.

According to the figure, User B has viewed the product pages of “Capacitors”, “Aluminum Electrolytic Capacitors”, “Type V-Series S”, “ECEV0GA101SR”, and “Type V-HB Series”.

On receiving an inquiry from the user terminal, the server judges with reference to the history database whether the user has viewed any product page of the product-code level. In the example shown in FIGS. 4, the judgment results in the negative if the inquiry is from User A, and in the affirmative if the inquiry is from User B. The resulting judgment is stored in the inquiry database.

The server provides to the user terminal, an inquiry stored in the inquiry database together with a corresponding judgment.

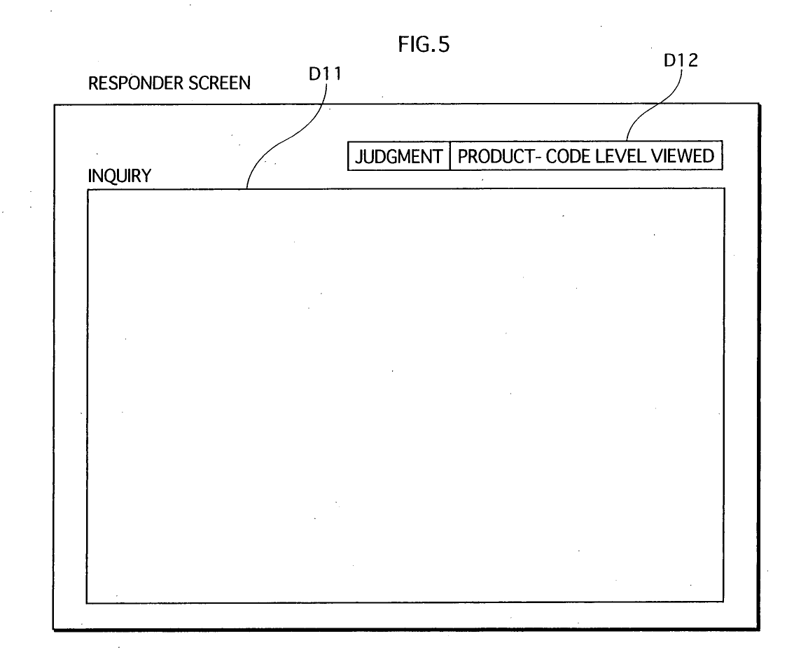

FIG. 5 shows an example of a display screen on the responder terminal displaying an inquiry.

The responder terminal displays the inquiry and judgment received from the server.

The inquiry is displayed in a display field D11, whereas the judgment is displayed in a display field D12. In the field D12, the message “Product-Code Level Viewed” appears when the received judgment is in the affirmative. On the other hand, if the received judgment is in the negative, the message “No Product-Code Level Viewed” appears in the field D12.

In the example shown in FIGS. 4, in response to an inquiry from User A, the inquiry is displayed in the field D11, and “No Product-Code Level Viewed” is displayed in the field D12. In response to an inquiry from User B, the inquiry is displayed in the field D11, and “Product-Code Level Viewed” is displayed in the field D12.

With this arrangement, the responder can assume that User B is relatively well-informed of the products, and thus determine to omit basic information from a response to the inquiry.

Further, suppose that an inquiry from a user is about a problem that the user has experienced in actually using a product of which a product-code is “ECEV0GA101SR”. In this case, the responder may make a different first response depending on whether the user has viewed the product page of “ECEV0GA101SR”. To be more specific, if User A makes such an inquiry, the responder requests, in his response, that User A first view the product page to check if the product is a suitable one to the use environment. On the other hand, if User B makes such an inquiry, the responder may provide, in his response, more detailed information that is not found on the product page.

As described above, since the system allows the responder to make an assumption on how much knowledge the user has on the products, the responder can make an appropriate answer without going thorough unnecessary troubles.

### EMBODIMENT 2

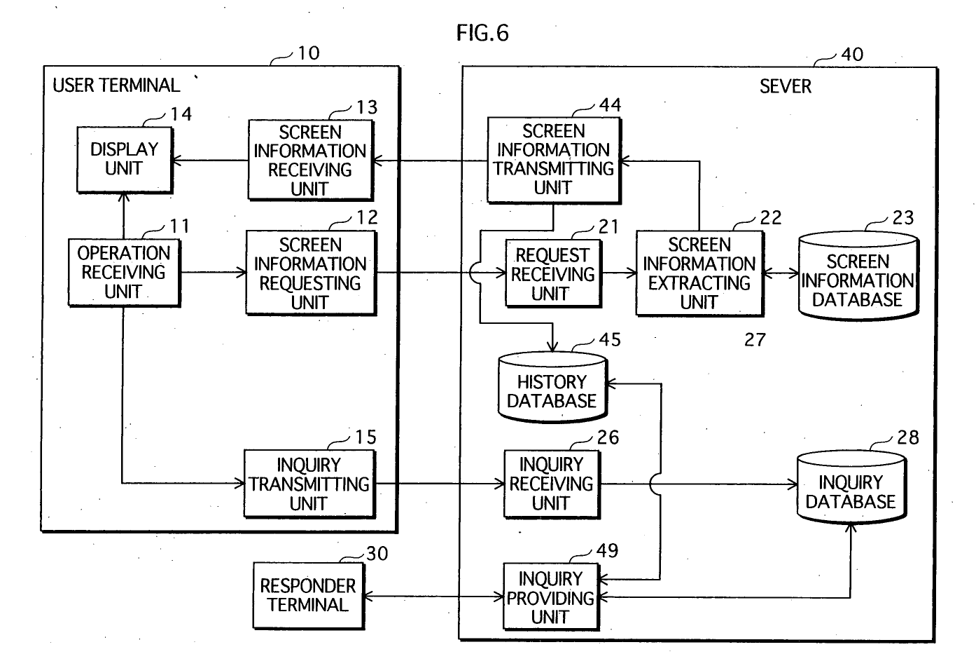

FIG. 6 is a diagram showing the structures of the user terminal, a server, and the responder terminal of an embodiment 2.

The structure of a server 40 differs from that of the embodiment 1 in functionality of a screen information transmitting unit 44, a history database 45, and an inquiry providing unit 49. Hereinafter, description is given exclusively to the differences.

The screen information transmitting unit 44 transmits an HTML file representing a product page to the screen information receiving unit 13. In addition, the screen information transmitting unit 44 inputs attribute information of the product page to the history database 45.

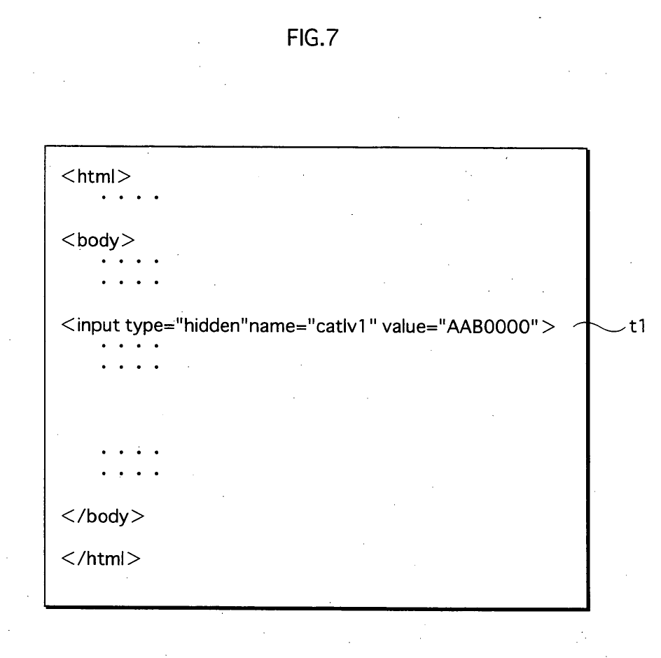

FIG. 7 is a view showing an example of an HTML file.

The HTML file includes a “name” tag and a “value” tag, and the tags describe attribute information of that HTML file (See t1).

The “name” tag describes that the level No. of the hierarchical level of the product page is “1”. In this example, the level No. “1” denotes a main-category level, “2” denotes a sub-category level, “3” denotes a series level, and “4” denotes a product-code level. The “value” tag describes that the page code is “AAB0000”. The screen information transmitting unit 44 recognizes the attribute of each product page by checking the tags mentioned above.

The history database 45 stores levels and page codes of all HTML files that the screen information transmitting unit 44 has transmitted.

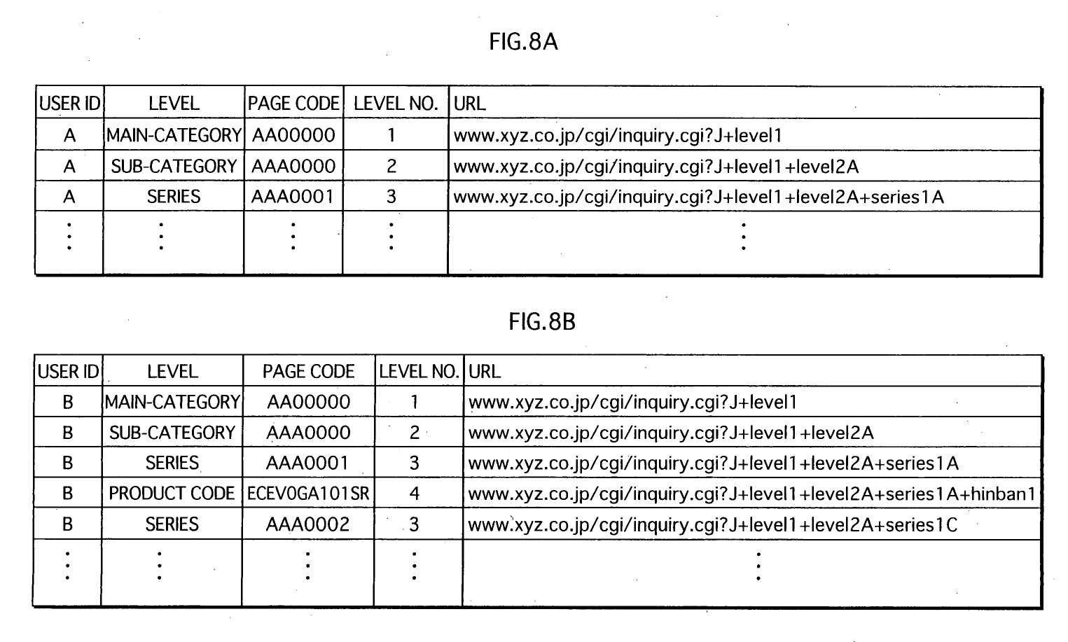

FIGS. 8 are views showing the contents of the history database.

FIG. 8A shows a browsing history of User A, and FIG. 8B shows a browsing history of User B.

The history database stores, separately for each user ID, hierarchical levels, page codes, level Nos., and URLs of product pages requested. The page codes and level Nos. are inputted by the screen information transmitting unit 44.

The inquiry providing unit 49 receives from the inquiry receiving unit 26, a notification that an inquiry has been received. In response, the inquiry providing unit 49 identifies names of the product pages, such as “Capacitors”, based on the page codes and level Nos. stored in the history database. The identification is carried out using a category database, a series database, and a product-code database.

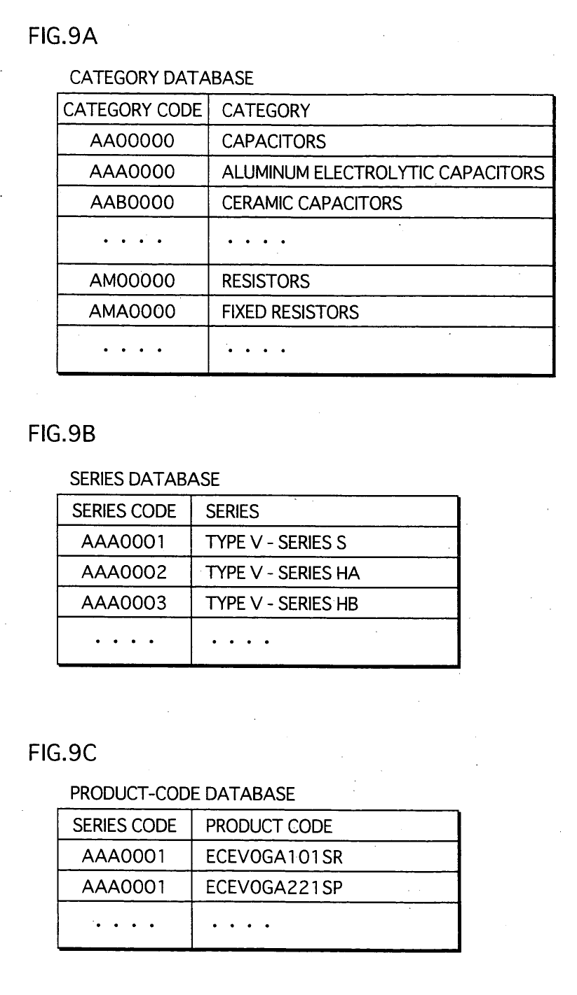

FIGS. 9 are views showing the category database, series database, and product-code database.

FIG. 9A shows the category database storing category codes along with corresponding category names.

The category database manages product pages at the main- and sub-category levels as shown in FIG. 3.

FIG. 9B shows the series database storing series codes along with corresponding series names.

The series database manages product pages at the series level as shown in FIG. 3.

FIG. 9C shows the product-code database storing series codes along with corresponding product codes.

The product-code database manages product pages at the product-code level as shown in FIG. 3.

Each of the code identifies a main-category with the first two digits, a sub-category with the third digit, and a series with the fourth to seventh digits. The above databases enable the inquiry providing unit 49 to recognize the hierarchical structure shown in FIG. 3.

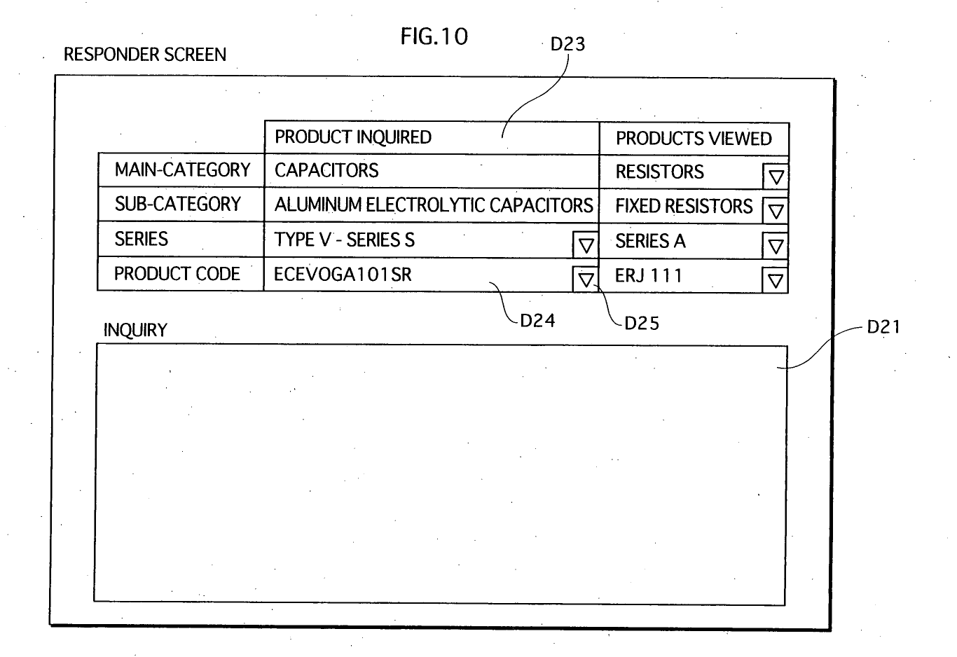

FIG. 10 shows an example of a screen display on the responder terminal 30 displaying an inquiry.

Displayed in a display field D23 is information about a product page on which the user clicks an inquiry button (hereinafter, referred to as a reference page). In addition, if any product pages subordinate to the reference page have been viewed by the user, information about those product pages is also displayed.

For example, a user clicks an inquiry button on a “Type V-Series S” page, “Type V-Series S” appears in the series field. If the user has viewed any product-code level product page that is subordinate to the “Type V-Series S” page, the product code corresponding to the viewed page appears in the product-code field (See FIG. 10, Display field D24). On the other hand, if the user has viewed no subordinate product pages, the display field D24 remains blank. Further, if the user has viewed more than one product pages subordinate to the “Type V-Series S” page, a list box D25 appears on the screen. The list box D25 is an icon indicating that there is more than one product page having viewed by the user. At a click on the list box D25, the responder can see the list of all the product pages of that level viewed by the user.

The inquiry page is linked to from all product pages. This means that the user may not always call the inquiry page from a product page relating to the product that the user is interested in. To be more specific, a user may first view product pages of the product-code level, and then views a product page of the series level where the user clicks an inquiry button. Even in such a case, the screen display as described above enables the responder to appropriately assume how much knowledge the user has on the products. Consequently, the responder can make an appropriate response to the inquiry without going thorough unnecessary troubles.

Although the above description is directed to the example in which the user clicks the inquiry button on a product page of the series level, similar description applies to the case where the user clicks an inquiry button on a product page of a sub-category level. For example, when the user clicks an inquiry page on the “aluminum electrolytic capacitors” page, which is classified as the sub-category level, “aluminum electrolytic capacitors” appears in the sub-category field. In this case, similarly to the above-described display, display appearing in the series field and the product-code field differs depending on whether the user has viewed any subordinate product page.

### MODIFICATIONS

(1) According to the above embodiments, the judgment is made as to whether a user has viewed a product page of the product-code level. Yet, the present invention is not limited thereto, and the judgment may be made regarding any of the following pages:

(a) Any arbitrary product page(s) preset by a provider of the electronic catalog;

(b) Product pages of a specific level in the hierarchical structure;

(c) Product pages at the lowest level in the hierarchical structure; and

(d) Product pages with a specific scores on the precondition that each product page is assigned a score in advance according to how detailed product information contained in the respective page is.

(2) According to the above embodiments, browsing histories of product pages viewed by users are stored. A judgment as to whether any product page of the product-code level has been viewed is made upon receiving an inquiry from a user. Yet, the present invention is not limited thereto. For example, each time a request for a product page is received from a user, a judgment is made as to whether the requested product page is of the product-code level. In this case, the resulting judgment is accumulated as a browsing history without other information. This modification ensures effective use the server memory.

(3) In response to an inquiry from a user, the server may provide a different inquiry page depending on the user's browsing history.

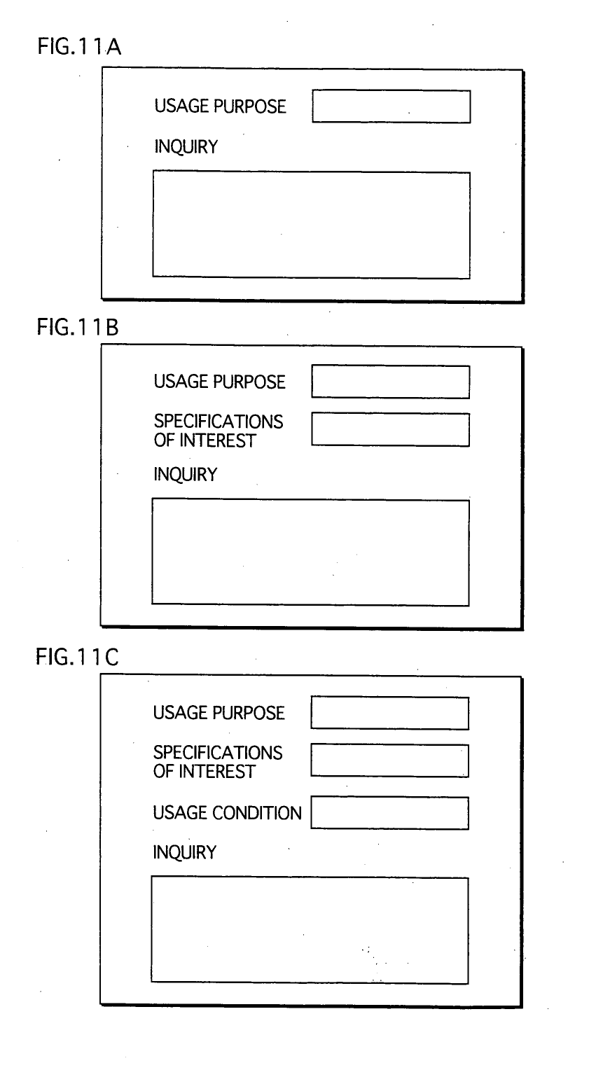

FIGS. 11 are views showing display examples of inquiry pages.

FIG. 11A shows an inquiry page having a field for entering a usage purpose.

FIG. 11 shows an inquiry page having, in addition to the usage purpose field, a field for entering specifications of user's interest.

FIG. 11C shows an inquiry page having, in addition to the usage purpose field and the specifications field, a field for entering usage conditions.

For example, to users having only viewed product pages at the main- and sub-category levels, the inquiry page shown in FIG. 11A is provided. To users having viewed product pages of up to the series level, the inquiry page shown in FIG. 11B is provided. Finally, to users having viewed product pages all the way to the product-code level, the inquiry page shown in FIG. 11C is provided.

With this arrangement, users with little knowledge on the products are requested to enter relatively simple information, whereas users with relatively good knowledge on the products are requested to enter more detailed information. That is to say, it is ensured to avoid requesting users to enter complicated information that may be beyond their knowledge on the products, and thus confusing the users.

Further, it may be applicable to present different screen displays to the responder depending on the type of inquiry page used.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. An inquiry processing apparatus for providing web pages to a browser terminal via a network, the web pages including an inquiry page for entering an inquiry and content pages other than the inquiry page, comprising:
a recording unit operable to record therein a history of the provision of content pages to the browser terminal;
a receiving unit operable to receive an inquiry entered into the inquiry page via the browser terminal;
a judging unit operable to judge, when the inquiry is received, whether a predetermined content page has been provided to the browser terminal, based on the history; and
a providing unit operable to provide the received inquiry and a result of the judgment to a responder for responding to the inquiry.

2. The inquiry processing apparatus according to claim 1, further comprising
a checking unit operable to check, each time a content page is provided to the browser terminal, whether the content page is the predetermined content page, wherein
the recording unit records a result of the checking as the history.

3. An inquiry processing method for use by an electronic catalog presenting apparatus that provides web pages to a browser terminal via a network, the web pages including an inquiry page for entering an inquiry and content pages other than the inquiry page, comprising:
a recording step of recording therein a history of the provision of content pages to the browser terminal;
a receiving step of receiving an inquiry entered into the inquiry page via the browser terminal;
a judging step of judging, when the inquiry is received, whether a predetermined content page has been provided to the browser terminal, based on the history; and
a providing step of providing the received inquiry and a result of the judgment to a responder for responding to the inquiry.

4. An inquiry processing program for use by a computer that provides web pages to a browser terminal via a network, the web pages including an inquiry page for entering an inquiry and content pages other than the inquiry page, comprising:
a recording step of recording therein a history of the provision of content pages to the browser terminal;
a receiving step of receiving an inquiry entered into the inquiry page via the browser terminal;
a judging step of judging, when the inquiry is received, whether a predetermined content page has been provided to the browser terminal, based on the history; and
a providing step of providing the received inquiry and a result of the judgment to a responder for responding to the inquiry.
